(19) United States
(12) Patent Application Publication
(10) Pub. No.: US 2020/0387652 A1
(43) Pub. Date: Dec. 10, 2020

(54) Computational Modeling of Procedural Language Descriptors Prior to Manufacture

(71) Applicant: Intact Solutions, Inc., Madison, WI (US)

(72) Inventors: Andrew Taber, Madison, WI (US); Goldy Kumar, Madison, WI (US); Michael Freytag, Madison, WI (US); Vadim Shapiro, Madison, WI (US)

(21) Appl. No.: 16/893,747

(22) Filed: Jun. 5, 2020

Related U.S. Application Data
(60) Provisional application No. 62/858,595, filed on Jun. 7, 2019.

(51) Int. Cl. G06F 30/23; G06F 17/12

(52) U.S. Cl. CPC G06F 30/23; G06F 2113/26; G06F 17/12

(57) ABSTRACT

Methods and systems for evaluation of a physical object directly from a manufacturing process plan are disclosed. A procedural representation of the object may be retrieved from a database. A non-conforming grid of basis functions representing physics to be applied may be determined. Boundary conditions for numerical integration over the object geometry may be determined. The boundary conditions may specify a physical boundary of a portion of the object geometry, and a physical condition applied over the portion. From the procedural representation, geometry and material rules for numerical integration over the portion of the object geometry may be determined. The basis functions may be numerically integrated over the object geometry, and a system of linear equations determined describing the physics subject to the boundary conditions. The system of equations may be solved to evaluate a physical quantity, and a graphical representation of the physical quantity may be displayed.

### CROSS-REFERENCE TO RELATED APPLICATIONS

This application claims priority under 35 U.S.C. § 119(e) to U.S. Provisional Patent Application Ser. No. 62/858,595, filed on Jun. 7, 2019, which is incorporated herein in its entirety by reference.

### STATEMENT REGARDING FEDERALLY SPONSORED RESEARCH OR DEVELOPMENT

This invention was made with government support under Subcontract No. 313363 awarded by the Defense Advanced Research Projects Agency. The government has certain rights in the invention.

### BACKGROUND

Engineering analysis and design systems may include one or more computing devices or systems that implement mathematical modeling, simulation, and analysis techniques for solving problems and/or evaluating design options that arise or are part of engineering tasks and projects. Non-limiting examples of such systems include computer-aided design (CAD) and computer-aided manufacturing (CAM) systems. Implementation may take the form of machine-language instructions, such as programming code, that translate mathematical equations and analyses into computational algorithms.

### SUMMARY

Many types of product manufacturing can be represented in procedural languages specified by procedural codes that encode one or more series of procedural steps that, when carried out by one or more devices, create or generate tangible products according to a design. An example of such a process is three-dimensional (“3-D”) printing, and an example of a procedural code is G-code. One challenge that arises with this type of manufacturing is that the product as manufactured may not always exactly match the product as designed. Furthermore, functional, performance, and/or other characteristics of the manufactured product may not be entirely known a priori or predictable from the design alone. It is therefore of interest to be able to predict and analyze how the manufactured product will compare and/or differ, in form, function, and performance characteristics, from the designed product prior to production in order to be able to adjust the design and/or manufacturing steps so at to achieve more accurate and/or improved agreement, as well as more reliable predictability of characteristics, and possibly optimized production operations.

Conventional techniques for analyzing products from procedural codes (such as G-code and/or those of other procedural languages) typically involve computer simulation of an analytical (e.g., mathematically-expressible) model of a product as it would be produced by the procedural code, and analyzing the properties of the simulated representation of the product. However, the computational process of simulating the “as-manufactured” product from an “as-planned” product described in a procedural code is generally cumbersome and tedious, and often yields an inaccurate representation of what the procedural code will actually produce. As a result, analyzing models of as-manufactured products in this manner may not only be computationally complex and expensive, but of limited accuracy both in terms of the simulations of the as-manufactured products and of the analyses of the properties studied based on the simulation models. In addition, conventional techniques can also involve prototyping of manufacturing steps in order to produce actual as-manufactured physical components for testing, and to evaluate the procedural code that drives and/or controls those manufacturing steps. It would therefore be desirable to overcome these, and other, deficiencies, shortcomings, and disadvantages of conventional approaches to analysis of procedurally-produced products.

Accordingly, the inventors have devised analytical techniques and algorithms that eliminate the need for simulating procedurally-produced products, and instead enable analysis of as-manufactured products based directly on the procedural code that is or will be used to produce the products. Example embodiments described herein provide computational techniques for accurate analytical evaluation of would-be procedurally-produced products that do not entail either simulation or actual production of the as-manufactured products, and that therefore circumvent the disadvantages of conventional approaches. Once a particular framework and/or system, such as a particular 3-D printer, that employs a specific procedural code-base implementation and specific manufacturing processes and materials is characterized, the techniques devised by the inventors may be applied generally to any as-manufactured product that can be produced by that framework or system and according to its specific procedural code-base. Significant time and expense may thereby be saved in design, development, and manufacturing of procedurally-manufactured products.

In one respect then, example embodiments may involve a method for simulation of physical performance of a physical object directly from a manufacturing process plan for the physical object, the method being carried out by a computing device and comprising: retrieving from a database a procedural representation of the object, the procedural representation specifying computer-controlled processing plans for manufacturing a tangible, as-manufactured version of the object; determining a spatial grid of basis functions representing physics to be applied in simulation to the as-manufactured version of the object, wherein the spatial grid does not conform with an object geometry descriptive of either an as-designed version of the object or the as-manufactured version of the object; determining boundary conditions for numerical integration over the object geometry, the boundary conditions comprising (i) a mathematical representation of a physical boundary of at least a portion of the object geometry and (ii) a physical condition applied in simulation over the at least a portion of the object geometry; determining from the procedural representation geometry rules and material rules for numerical integration over the at least a portion of the object geometry, wherein the geometry rules specify spatial quadrature points and associated weights of quadrature rules, and the material rules specify effective material properties at the quadrature points; numerically integrating the basis functions over the object geometry according to the quadrature rules and the effective material properties at the quadrature points, in order to determine a system of linear equations that mathematically describe the physics subject to the boundary conditions as applied in simulation to the as-manufactured version of the object; solving the system of linear equations to evaluate at least one physical quantity of the physics applied in simulation to the as-manufactured version of object; and displaying a graphical representation of the evaluated at least one physical quantity in a display device.

In another respect, example embodiments may involve a system for simulation of physical performance of a physical object directly from a manufacturing process plan for the physical object, the system comprising: one or more processors; memory, and instructions stored in the memory that, when executed by the one or more processors, cause the system to carry out operations including: retrieving from a database a procedural representation of the object, the procedural representation specifying computer-controlled processing plans for manufacturing a tangible, as-manufactured version of the object; determining a spatial grid of basis functions representing physics to be applied in simulation to the as-manufactured version of the object, wherein the spatial grid does not conform with an object geometry descriptive of either an as-designed version of the object or the as-manufactured version of the object; determining boundary conditions for numerical integration over the object geometry, the boundary conditions comprising (i) a mathematical representation of a physical boundary of at least a portion of the object geometry and (ii) a physical condition applied in simulation over the at least a portion of the object geometry; determining from the procedural representation geometry rules and material rules for numerical integration over the at least a portion of the object geometry, wherein the geometry rules specify spatial quadrature points and associated weights of quadrature rules, and the material rules specify effective material properties at the quadrature points; numerically integrating the basis functions over the object geometry according to the quadrature rules and the effective material properties at the quadrature points, in order to determine a system of linear equations that mathematically describe the physics subject to the boundary conditions as applied in simulation to the as-manufactured version of the object; solving the system of linear equations to evaluate at least one physical quantity of the physics applied in simulation to the as-manufactured version of object; and displaying a graphical representation of the evaluated at least one physical quantity in a display device.

In still another respect, example embodiments may involve a non-transitory computer-readable medium having instructions stored thereon that, when executed by the one or more processors of a system for simulation of physical performance of a physical object directly from a manufacturing process plan for the physical object, cause the system to carry out operations including: retrieving from a database a procedural representation of the object, the procedural representation specifying computer-controlled processing plans for manufacturing a tangible, as-manufactured version of the object; determining a spatial grid of basis functions representing physics to be applied in simulation to the as-manufactured version of the object, wherein the spatial grid does not conform with an object geometry descriptive of either an as-designed version of the object or the as-manufactured version of the object; determining boundary conditions for numerical integration over the object geometry, the boundary conditions comprising (i) a mathematical representation of a physical boundary of at least a portion of the object geometry and (ii) a physical condition applied in simulation over the at least a portion of the object geometry; determining from the procedural representation geometry rules and material rules for numerical integration over the at least a portion of the object geometry, wherein the geometry rules specify spatial quadrature points and associated weights of quadrature rules, and the material rules specify effective material properties at the quadrature points; numerically integrating the basis functions over the object geometry according to the quadrature rules and the effective material properties at the quadrature points, in order to determine a system of linear equations that mathematically describe the physics subject to the boundary conditions as applied in simulation to the as-manufactured version of the object; solving the system of linear equations to evaluate at least one physical quantity of the physics applied in simulation to the as-manufactured version of object; and displaying a graphical representation of the evaluated at least one physical quantity in a display device.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF DRAWINGS

FIG. 1 depicts a simplified block diagram of an example computing device, in accordance with example embodiments.

FIG. 2 depicts a simplified block diagram of an example cloud-based server cluster, in accordance with example embodiments.

FIG. 3 illustrates an example process flow for analysis of as-manufactured products using conventional modeling approaches.

FIG. 4 illustrates an example process flow for analysis of as-manufactured products directly from process plans, in accordance with example embodiments.

FIG. 5 depicts an example spatial grid that does not conform to the geometry of an example object described by a design plan, in accordance with example embodiments.

FIG. 6 illustrates an intersection of an example of unevaluated procedure code with a spatial cell of a non-conforming grid, in accordance with example embodiments.

FIG. 7A illustrates an example process flow for numerical integration over spatial cells of a non-conforming grid, in accordance with example embodiments.

FIG. 7B illustrates another example process flow for numerical integration over spatial cells of a non-conforming grid, in accordance with example embodiments.

FIG. 8 illustrates non-limiting examples of applications and/or uses of performance analysis that is derived directly from process plans of as-manufactured products, in accordance with example embodiments.

FIG. 9A is conceptual illustration of a geometric representation of a portion of a first example process plan and associated quadrature points for numerical integration, in accordance with example embodiments.

FIG. 9B is conceptual illustration of a geometric representation of a portion of a second example process plan and associated quadrature points for numerical integration, in accordance with example embodiments.

FIG. 9C is conceptual illustration of a geometric representation of a portion of a third example process plan and associated quadrature points for numerical integration, in accordance with example embodiments.

FIG. 9D is conceptual illustration of a geometric representation of a portion of a fourth example process plan and associated quadrature points for numerical integration, in accordance with example embodiments.

FIG. 9E is conceptual illustration of a geometric representation of a portion of a fifth example process plan and associated quadrature points for numerical integration, in accordance with example embodiments.

FIG. 10 is a flow chart of an example method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Example embodiments herein are directed to providing computational techniques implemented by a computing system for accurate analytical evaluation of procedurally-produced products based directly on a procedural code describing the manufacture process, without either simulating or actually producing the procedurally-produced products. The analytical evaluation enabled and supported by the computation techniques includes, but is not limited to, predicted performance of as-manufactured products, comparison of as-manufactured products with the products as designed, assessment of process plans and as-planned products, assessment of planned manufacturing method characteristics, and assessment of planned manufacturing material. In example embodiments, the procedural representation could be specified in a procedural code such as G-code. However, other procedural representations, languages, and/or codes could be used.

### I. Introduction

Many types of product manufacturing can be represented in procedural languages specified by procedural codes that encode one or more series of procedural steps that, when carried out by one or more devices, create or generate tangible products according to a design. Sometimes referred to as Numerical Control (NC) manufacturing, such automated or semi-automated manufacturing may entail programs and/or plans that control motion of NC machines used for programmable manufacturing. In other cases, computers may control the flow and processing of the moving raw materials that are being transformed into a final product.

A common form of an NC plan specification is G-code, which may specify a one-dimensional path of a tool used during manufacturing. Example embodiments herein are described assuming process plans specified in G-code. However, other descriptions of manufacturing plans are possible, and the references to G-code herein are not limiting, nor are they intended to be.

Manufacturing using computer-controlled plans can take various forms depending, for example, on whether a product is manufactured by adding material, by removing or subtracting material, or causing or invoking a phase change of material. Example embodiments described herein apply to process-plan manufacturing involving any of these or other forms of manufacturing. An example of an “additive manufacturing” process is 3-D printing. An example of “subtractive manufacturing” is computer NC (CNC) manufacturing, in which, for example, a machine (or machines) operating under computer control (e.g., G-code) incrementally, and in a controlled and planned manner, remove material from an object. An example of “phase-change manufacturing” is foam making. Example embodiments described herein may also apply to process-plan manufacturing involving a mix these and/or other possible modes in a “heterogeneous manufacturing” process.

For purposes of illustration, and by way of example, embodiments herein will be described primarily in terms of, or in the context of, additive manufacturing or “AM.” Non-limiting examples of additive manufacturing using NC plans are listed in Table 1.

TABLE 1

| Process | Examples/Description |
|---|---|
| Path-Based Additive | Extruder path for Fused Deposition Modeling |
| Manufacturing | Laser paths for Selective Laser Sintering and |
| | Direct Metal Laser Sintering |
| Composite Additive | Prepregged tape laid using G-code |
| Manufacturing | Fiber reinforced composites |
| Other Discretized | Section by section (slice by slice), e.g., |
| Control | stereolithography |
| Manufacturing | Point-by-point (usually array of points) |

It may be noted that, while parts are often sectioned (sliced) first in order to create a tool path, tool paths may also follow curved surfaces.

An aspect of process-plan manufacturing that is of particular interest is evaluation of manufacturing plans. The inventors have recognized that in order for manufacturing plans to be accurate and efficient, it is beneficial—and sometimes necessary—to be able to analytically evaluate manufacturing plans in an accurate and efficient manner. It may be useful summarize some of the reasons.

In practice, performance of as-planned or as-manufactured parts or products (or more generally tangible “objects”) may differ—sometimes significantly—from that of the as-designed parts or products. This is because an AM process creates simultaneously both geometry and material that are typically different from a nominal designed part that was used to create the process plan. Not only can the geometry generated by manufacturing operations differ from that of the designed geometry, but also the material properties of deposited/fused material are usually heterogeneous, anisotropic, and may not be known a priori, for example. The terms “geometry” and “material properties” may be context-dependent.

In reference to as-designed, as-planned, and/or as-manufactured objects, geometry may refer to the boundary surfaces of the object that are approximated by the additive process. However, geometry may also refer to detailed geometry interior to the shape, including gaps, voids, and other features—whether these are intentional or unintentionally created.

The term material properties may be scale dependent. For example, it could refer to properties of a base material used to make the part (e.g., filament, metal, resin, etc.) which may be determined by separate simulation and/or experimentally. It can also refer to “effective material properties,” which may be averaged over some portion of a part or interior region manufactured with some “infill” pattern. The effective properties may be determined by how individual “roads” and/or “sections” of deposited material are bonded and fused together during or as a result of the manufacturing process. Interpretation of this term is dependent on the relevant scale under consideration.

Evaluation of manufacturing plans is also beneficial in determining performance of the as manufactured parts and comparing their performance with that predicted and/or required of corresponding as-designed parts. Evaluation may further enable selecting, improving, and optimizing manufacturing strategies, for example, by selecting different materials, paths, infill patterns and process control parameters in AM, when finding an optimal manufacturing plan for a designed part. While performance may, in principle, be determined by physical testing, such an approach can (and in practice often does) lead to inefficient iterative trial-and-error that is slow and wasteful in both energy and materials.

As described by way of example herein, performance analysis generally refers to any engineering analysis that simulates physical behavior of a component on a computer given its geometry, materials, and applied boundary conditions, usually by numerically approximating a solution to a boundary value problem. A common type of performance analysis is structural analysis, where displacements and stresses in the part are predicted from given restraints and loads. Accordingly, example embodiments herein are discussed in terms of structural analysis. However, the principles, operations, and/or steps described in the context of structural analysis apply and/or are similar in the contexts of other types of analyses, such as thermal, fluid, and electromagnetic, for example.

Conventional approaches to performance analysis typically entail simulation of both as-manufactured objects and analysis of simulated as-manufactured objects. The inventors have recognized that performance simulation from manufacturing plans poses challenges because, among other reasons, the geometry that results from evaluation of a procedural code, such as G-code, is typically very complex and difficult to mesh. Furthermore, the geometry derived from the procedural code generally does not conform to the design geometry upon which designers typically specify boundary conditions. The term “mesh” used herein refers to an analytical process of approximating a geometric description, such as a surface and/or volume shape, by numerous well-defined discrete elements. For a surface geometry, the discrete elements could be polygons arranged in a mesh that approximates the surface. For a volume geometry, the discrete elements could be voxels arranged in a configuration that approximates the volume.

The inventors have devised analytical techniques and algorithms that enable performance evaluation of as-manufactured objects directly from procedural code. In particular, the approach devised by the inventors avoids the need to simulate the manufacturing process, thereby avoiding not only the computational complexity of the simulation, but the often challenging meshing of the geometry from the manufacturing simulation. In addition, analysis directly from the procedural code avoids analysis of a simulated, meshed representation that may itself be of limited accuracy. The analytical techniques and algorithms devised by the inventors may be implemented as computer or machine-language code that, when executed or carried out by a computing system or device, cause the computing system or device to carry out various operations and/or methods described herein. Before discussing the analytical techniques and algorithms, and corresponding computational operations and/or methods, example computing devices and systems are described.

### II. Example Computing Devices and Systems

Example embodiments disclosed herein may be implemented in and/or include computing systems and/or devices and methods carried out by the computing systems and/or devices. Example computing systems and/or devices may include one or more special and/or general purpose processes, volatile and non-volatile storage, including non-transient machine readable media, such as magnetic disk, solid state memory, among others. Systems may also include a user interface, including interactive input devices, such as keyboards, and display devices and graphical user interfaces (GUIs).

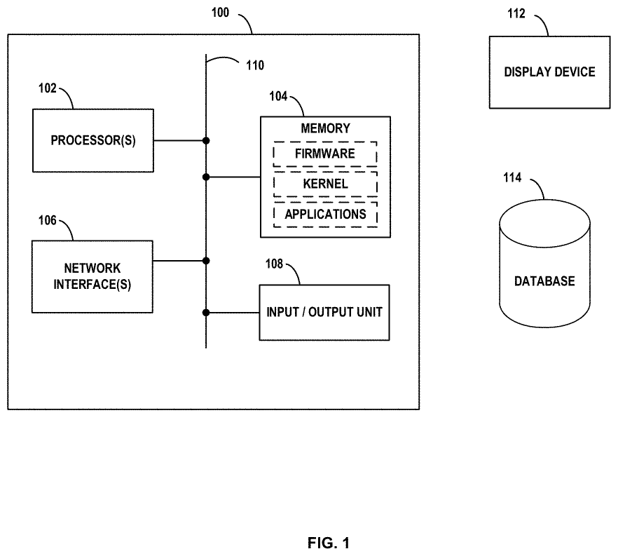

FIG. 1 is a simplified block diagram of an example computing device 100, according to example embodiments. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features. As shown, the computing system 100 includes processor(s) 102, memory 104, network interface(s) 106, and an input/output unit 108. By way of example, the components are communicatively connected by a bus 110. The bus could also provide power from a power supply (not shown). In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 902 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. By way of example, the memory 104 may include firmware, a kernel, and applications, among other forms and functions of memory. The memory 104 may store machine-language instructions, such as programming code, that may be executed by the processor(s) 102 in order to carry out operations that implement the methods and techniques described herein. Memory 104 may also store data used by these and other programs and applications.

Network interface(s) 106 may provide network connectivity to the computing system 100, such as to the internet or other public and/or private networks, and may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 906 may additionally take the form of one or more wireless interfaces, such as IEEE 802.11 (Wife), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with example computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example

FIG. 1 also includes a display device 112 and a database 114. The display device may be a user client or terminal that includes an interactive display, such as a GUI. It may be used for user access to programs, applications, and data of the computing device 100. For example, a GUI could be used for graphical rendering of shapes corresponding to objects over which the integration technique is applied.

The database 114 could include data describing one or more objects according to procedural code. The data could be in a format corresponding to a particular formalism. Additionally or alternatively, the database could store intermediate and final results of a moment-vector technique. For example, the database could store moment-vectors computed for a library of objects. The database 114 could be used for other purposes as well.

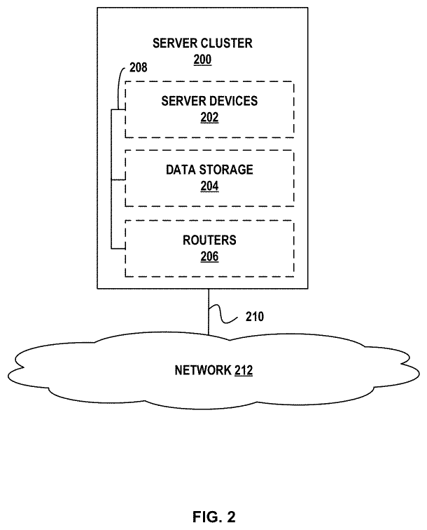

FIG. 2 depicts a cloud-based server cluster 200 in accordance with example embodiments. In FIG. 200, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 200. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of cluster data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via cluster network 208, and/or (ii) network communications between the server cluster 200 and other devices via communication link 210 to network 212.

Additionally, the configuration of cluster routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. In an example embodiment, data storage 204 could correspond to one or more instances of database 114. Various types of data structures may store the information in such a database, including but not limited to tables, arrays, lists, trees, and tuples. Furthermore, any databases in data storage 204 may be monolithic or distributed across multiple physical devices.

### III. Computational Modeling of Procedural Language Descriptors Prior to Manufacture

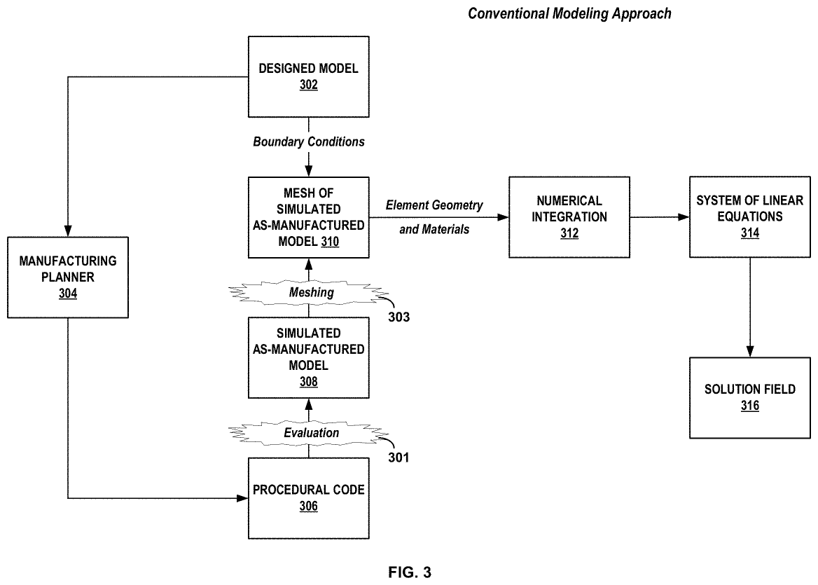

In order to appreciate the benefits and advantages of deriving performance evaluation directly from process plans, it may be useful to consider a typical example of how performance evaluation is conventionally obtained. FIG. 3 illustrates an example process flow for analysis of as-manufactured products using a conventional modeling approach. In the example flow, a designed model 302 describing an as-designed version of an object may be processed by a manufacturing planner 304 that generates procedural code 306 for producing or manufacturing an as-manufactured version of the object.

By way of an evaluation process 301 that is typically computationally costly and sometimes of limited accuracy, a simulated as-manufactured model 308 is generated. The evaluation process 301 may be costly due to both the complexity of translating simulated evaluation of the procedure code into a simulation model of the as-manufactured object, and a general lack of standard way of achieving the simulation that can be applied to any process plan without significant customization of the computational steps involved. The accuracy may be limited for the same reasons.

In a next step, the simulated as-manufacture model 308 is converted to a further approximation by a meshing procedure 303 that represents the as-manufactured model 308 as mesh 310. As described above, the mesh of an as-manufactured model (or other geometrically-described object) may be or include a surface mesh of discrete surface elements (e.g., Euclidean and/or non-Euclidean polygons), and/or a volume configuration of discrete volume elements (e.g., voxels). The meshing process 303 may suffer from the same or similar computational costliness and/or inaccuracies as the evaluation procedure 301. Namely, complexity, lack of one-size-fits-all (or even many) standards, and lack of fidelity translating the simulated geometry to the approximating mesh 310 (or voxel) representation. As a result, the mesh 310 may provide a deficient starting point for the subsequent performance analysis.

In the next step, boundary conditions are derived from the designed model 301 and the particular physics of forces and/or actions to be applied in simulation to the mesh 310 of the simulated as-manufactured model. Numerical integration 312 is then applied to the element geometry corresponding to the mesh elements, together with description of properties of the materials to be used in the actual as-manufactured object. The numerical integration 312 yields a system of linear equations 314 that analytically represent the physics applied in simulation to the mesh 310 of the as-manufactured model. Standard techniques may be used for solving the system of equations 314, resulting in solution field 316 that may then be used to visualize the solution results. For example, stresses or strains applied in simulation may be represented graphically in a display device in a 3-D rendering.

In addition to the complexity and limited accuracy of generating the simulated as-manufactured model 308 from the evaluation 301 of the procedural code 306, and the similar complexity and limited accuracy of generating the mesh 310 of simulated as-manufactured model 308 from the meshing process 303, the numerical integration 312 may also be of limited accuracy. This is because it is applied to inputs that may be inherently inaccurate to begin with. The above description of an example conventional approach to simulation of evaluation of as-manufactured objects may provide a context for understanding the benefits and advantages of performance evaluation derived directly from process plans. Embodiments of the direct approach is now described by way of example.

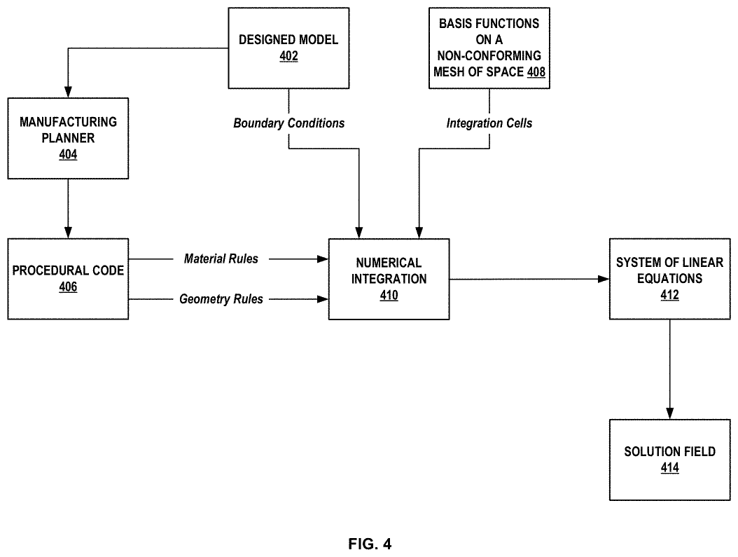

FIG. 4 illustrates an example process flow for analysis of an as-manufactured product derived directly from process plans, in accordance with example embodiments. In the example flow, a designed model 402 describing an as-designed version of an object may be processed by a manufacturing planner 404 that generates procedural code 406 for producing or manufacturing an as-manufactured version of the object. In accordance with example embodiments, the designed model 402 represents the original and/or intended designed geometry of the object (e.g., product or part). The designed model is typically created by a computer aided design (CAD) program or system. It may also take the form of an explicit representation, such as B-rep, surface mesh, or voxels, for example.

The procedural code, such as G-code, is usually a manufacturing language that is used to control NC machines that are used for manufacturing. Conceptually (and in the example of additive manufacturing), the procedural code 406 may be thought of as specifying a path through space over which material used to additively manufacture the object will be “laid out” and a speed at which it is laid out. The term “laid out” as used herein in the context of AM is a loosely technical description of a process for incrementally creating a material form along a path in space. The material laid out according to the path, speed, and a shape is customarily referred to as the “road,” in analogy to the laying of a terrestrial road or highway, for example. In practical applications of AM, a road may be laid out by one or more of a variety of processes carried out along a specified path, and using one or more of a variety of materials.

In accordance with example embodiments, as described below, procedural code may further be used to drive both the integration over the as-planned geometry in construction of the linear system describing the performance of the as-manufactured shape, and the material properties of the as-planned material that may vary based on such manufacturing parameters as orientation and deposition rate.

Generating procedural code from an as-designed model or specification may be carried out by software applications colloquially known as a “slicers.” Considering G-code as an example, slicers take design models and generate the G-code that may be fed to one or another form of additive manufacturing hardware. The term slicer refers to a procedure by which the design model is intersected—or “sliced”—with a sequence of parallel planes. Process plans then specify sequentially filling the resulting 2-D cross-sections using 1-D toolpaths that are encoded in G-code. The toolpaths include “shells” that specify generating the outside surface of the object to be manufactured. Interior toolpaths can follow a wide range of patterns that lead to complex 3-D interior structures (e.g., infill).

Unlike conventional approaches, numerical integration 410 may be applied directly to the “unevaluated” procedural code by providing “material rules” and “geometry rules” as indicated, together with boundary conditions and basis functions on a non-conforming mesh of space that specifies “integration cells.” Boundary conditions are the mathematical representation of the physical conditions that the designed physical object is expected to undergo or will be subject to. A boundary condition will usually consists of a portion of the designed geometry's boundary and a physical condition applied to that portion of geometry.

The basis functions are specified on a non-conforming grid, and represent the physics of the analysis. The non-conforming grid may be considered as representing a spatial grid of cells of defined according to a coordinate system that is independent of the geometry of the object. The geometry of the object may thus be thought of as being immersed in the grid, where the intersection of each cell with the object geometry specifies a discrete portion of the object over which the basis functions are evaluated and the boundary conditions applied.

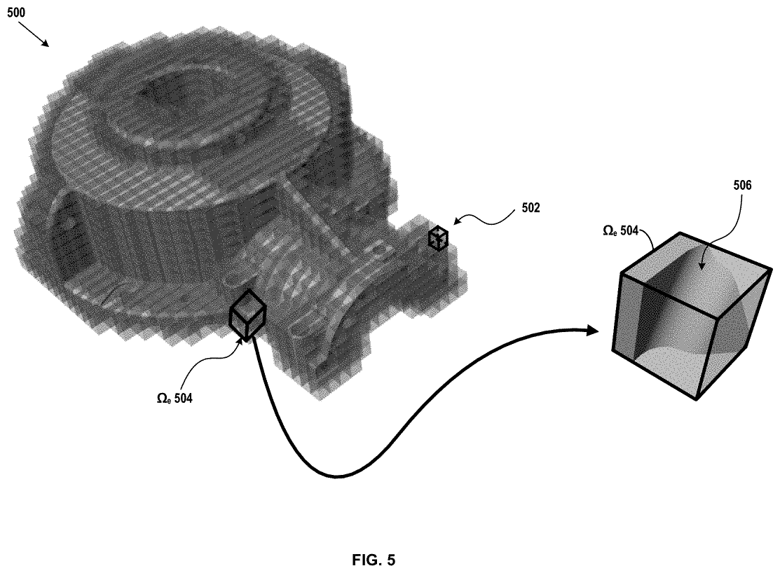

An example spatial grid 500 that does not conform to the geometry of an example object described by a design plan is illustrated in FIG. 5. The object depicted in FIG. 5 is illustrative and arbitrary; it could be a designed machine part, such as a part of an automobile engine, for example. The figure also illustrates a representative cell 502, as well as the intersection of a cell Ωₑ 504 with the designed model of the object. A magnified view of the cell Ωₑ 504, including its intersection with the object portion 506 is depicted on the right side of FIG. 5, where a curved arrow points from the cell Ωₑ 504 in the grid 500 to the magnified view. In accordance with example embodiments, the procedural code may be used to determine the planned manufacturing path through the cell Ωₑ 504 and its intersection with cell Ωₑ 504.

Since analysis, including numerical integration, is carried out for each grid cell, the grid cells may also be referred to as “integration cells.” The collection of integration cells spans the basis functions.

In accordance with example embodiments, the material rules describe and/or specify material properties according to a process plan. Material properties may be considered to take on certain values or may be implied by a certain process plan. In the case of material properties that are influenced by the manufacturing processes, such material properties may be incorporated into the numerical integration, thus producing simulation results that are more aligned with the as-manufactured object response. Material rules may be scale dependent, where scale may be determined by the size of integration cells. Also in accordance with example embodiments, material rules can be obtained from databases of published data, experiments, such as test samples, or simulation at finer scales (e.g., to determine an effective property of infill pattern). The availability and use published and/or experimental data may be used to enhance or expand applicability of methods and procedures described herein, thereby making them more universal.

Conceptually, the material rules may be thought of as specifying properties of the road as it is laid out according to the geometry rules. Material rules may encompass inherent properties, such as material composition and small-scale structure, where “small-scale” refers to a scale small in comparison to a scale or resolution of the analysis being carried out (e.g., integration or grid cells). As an example, a material rule concerning inherent, small-scale structure could describe small fibers and fiber direction in material as it is laid out in a road. Material rules may alternatively or additionally encompass scale-dependent properties that capture effective properties resulting from, and/or corresponding to, structures created by the AM process that are large compared with the scale or resolution of the analysis being carried out. An example of a large-scale structure could be a pattern of voids in a portion of the manufactured object, or an infill pattern.

In accordance with example embodiments, the geometry rules may be used to transform the procedural code into quadrature rules and weights that take into account the distribution of material within the basis function grid. The quadrature points specify spatial point within each integration cell at which the various functions of the numerical integration are evaluated.

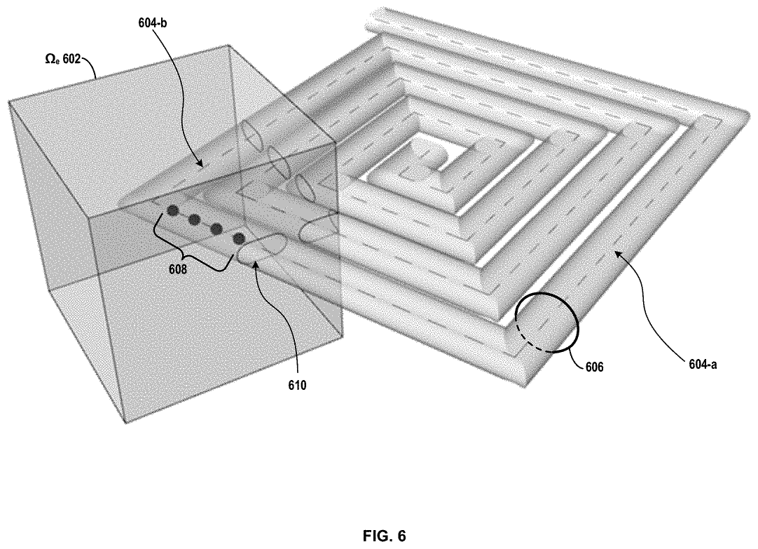

FIG. 6 illustrates an intersection of an example of unevaluated procedure code with a spatial cell Ωₑ 602 of a non-conforming grid, in accordance with example embodiments. The procedural code path is represented by a non-intersecting path segment 604-a external to the cell IL 602, and an intersection path segment 604-b internal to the cell. The path segments and speed along the path of the road-laying process, together with information about the manufacturing process descriptive of the formation of the material as it is laid out, can determine or imply the shape of the road. In FIG. 6, the road 606 is illustrated conceptually. The intersection of the road 606 with the cell IL 602 describes an approximate road cross-section 610; approximate in the sense that it is not perpendicular to the path 604-b. More precisely, the cross-section of the road is defined normal (perpendicular) to the path. By way of example, four quadrature points 608 are also indicated on the path segment 604-b within the cell Ωₑ 602. Although not explicitly shown in this illustration, there may be additional quadrature points on all of the path segments interior of the cell Ωₑ 602.

Returning again to FIG. 4, the numerical integration 410 is carried out over each integration cell, and then summed to yield the system of linear equations 412 applied to the as-manufactured object in its entirety. The numerical integration is domain integration and surface integration used to compute physical property matrices and vectors, depending on the physics being simulated. In particular, example embodiments herein provide domain integration of unevaluated procedural code. Examples are discussed in more detail below.

The system of linear equations 412 may be represented as Ax=B, where A is a matrix, B is a vector, and x is a vector of unknown coefficients. The solution field 414 is a field that results from the coefficient vector x obtained after solving the linear system. The solution field depends on the physics being simulated. For example, displacement is the solution field when simulating linear elasticity physics.

Standard techniques may be used for solving the system of equations 412, resulting in solution field 414 that may then be used to visualize the solution results. For example, stresses or strains computed in simulation may be represented graphically in a display device in a 3-D rendering.

In further accordance with example embodiments, specific manufacturing devices and/or systems may be employ well-defined and/or well-specified materials and processing operations. For example, a particular make and model of 3-D printer may be configured to implement a specific set of AM operations specified by a particular G-code code base, and using a specific material or set of materials in one or more specific “road-laying” processes. As such, a process plan for any object that can be made by the particular make and model of the 3-D printer may be specified using the same G-code building blocks and the same material descriptions. For instance, a particular 3-D printer may use a particular extrusion process with a particular material. In the context of the example embodiments described herein, the material rules and geometry rules that enable the derivation of performance evaluation directly from G-code may therefore be the same, and/or straightforwardly determined, for any object designed for manufacture by the particular 3-D printer.

This concept may be described as a “universality” of the example methods, at least within a particular universe describable by consistent material properties and procedural operations of a procedural code base. In principle, the particular “universe” may be extended or expanded by inclusion of material rules that can be obtained from databases of published data, experiments, for example. Advantageously, performance evaluation derived directly from procedural code may thus provide a foundation with nearly universal applicability. This is something that conventional approaches cannot do.

### A. [0068] Numerical Integration

Various approaches may be taken for carrying out numerical integration. Two non-limiting examples are considered below. In a first approach, manufacturing primitives implied by a manufacturing process plan may be intersected with the supports of the basis functions in the basis function grid. For example, as illustrated conceptually in FIG. 6, G-code (or another procedural code) can imply linear path segments which are trimmed to supports of basis functions, and quadrature points may be distributed over the resulting trimmed path to carry out numerical integration of a physical property matrix (e.g., stiffness matrix, thermal conductivity matrix, etc.).

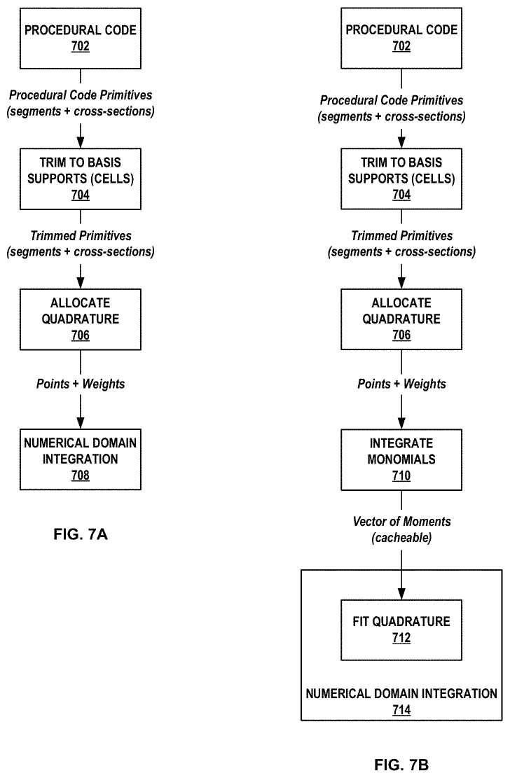

The first approach is represented in FIG. 7A, which illustrates an example process flow for numerical integration over spatial cells of a non-conforming grid, in accordance with example embodiments. As shown, procedural code 702 may be used to infer or imply from code primitives path segments and cross-sections. The next operation 703 trims the code primitives to the basis supports. This entails intersecting the paths with the cells. In operation 706, quadrature points are allocated, yielding quadrature points and weights (quadrature rules). Finally, operation 708 involves numerical domain integration.

A second approach to domain integration is similar to the first, except the physical property matrix is replaced by a vector of monomials defined over the integration cells. The result is a vector of moments that can be used to construct quadrature rules for integration of the physical property matrix over the cell. Once the vector of moments has been computed, it may be cached to facilitate future integrations over the cell.

The second approach is represented in FIG. 7B. As shown, procedural code 702 may be used to infer or imply from code primitives path segments and cross-sections. The operations are the same as the first method through 706. In the second approach, the quadrature rules are used in operation 710 to integrate over monomials. This may produce vector moments that can be saved for multiple uses (e.g., save in cache). In particular, domain integration 714 may fit the quadrature 712 to achieve multiple of cell integrations over a variety of functions.

Other integration strategies are possible as well, including ones that allow local integration over supports of basis functions based on geometry and material properties implied by manufacturing process plan.

### B. Boundary Conditions

Because analysis from procedural code does not require explicit global generation of the as-planned geometry, the application of boundary conditions may present some challenges. Boundary conditions come in two forms: natural boundary conditions and essential boundary conditions. Natural boundary conditions are handled by numerical (surface) integration, and thus require techniques to integrate over portions of the boundary where these boundary conditions are applied. Essential boundary conditions may be handled by a variety of techniques, one of which is to modify the linear system based on distance to the boundary where essential conditions are applied. Both types of boundary conditions require mapping between the designed geometry where the condition is applied to the corresponding geometry of the as-planned model. Three methods for performing this mapping are described here, in accordance with example embodiments.

In the first method of mapping, boundary segments of the as-designed geometry may be used directly for application of boundary conditions. This method may avoid the problem of mapping altogether, but it is generally only applicable when there is sufficiently close spatial coherence between the as-designed and the as-planned geometry.

In the second method of mapping, the as-planned geometry implied by the procedural code may be generated in the neighborhood of the boundary condition. The boundary of the as-planned geometry can then be used for application of the boundary condition. Additional computations may be used to generate only those portions of the as-planned geometry that correspond to the segments of the as-designed geometry to which boundary conditions are applied. This correspondence may be determined by distance, visibility, and/or orientation, for example.

In the third method of mapping, the primitive procedural code geometry corresponding to the boundary segments of the as-designed geometry may be used to apply boundary conditions without evaluating the full as-planned geometry implied by the procedural code. As with the second method of mapping, the correspondence may be determined by distance, visibility, and/or orientation, among others. To treat the boundary conditions in this manner may require replacing the surface integrals over the as-designed geometry with curve integrals over the corresponding procedural code primitives. Curve integration weights are adjusted to ensure equivalence to integration over the as-planned geometry.

### C. Sample Applications

The ability to evaluate performance of as-planned parts directly from manufacturing process plans may provide numerous applications and cost-saving opportunities. For example, it can become possible to determine a priori whether a planned manufacturing process may produce parts (or other products) that will function in a manner consistent with their designs. Furthermore, rapid performance evaluation directly from process plans can support systematic selection and optimization of best manufacturing strategies.

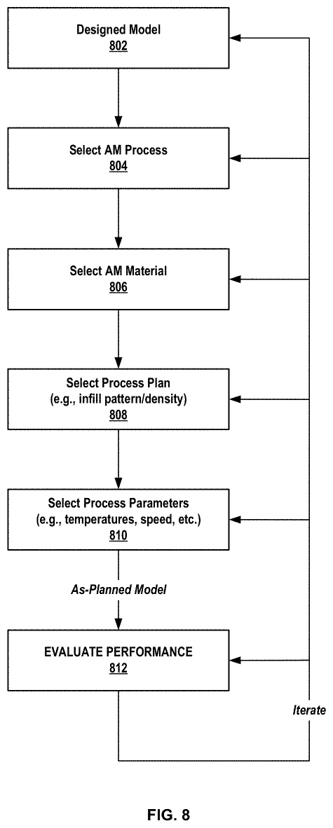

FIG. 8 illustrates non-limiting examples of applications and/or uses of performance analysis that is derived directly from process plans of as-manufactured products, in accordance with example embodiments. In particular, the various selection steps in FIG. 8 may define and/or configure various elements of process flow for creating an as-manufactured object. The selections may also serve as data that supports or guides the methods and procedures described above for performance analyses of an as-manufactured object. The performance evaluation derived directly from procedural code may then be used to adjust or adapt any or all of the selections in an iterative loop, thereby supporting optimization the selections. Because the selections are the same or closely related to those made for actual manufacture of the as-manufactured object, the adjustments determined through the iterative modeling loop correspondingly provide improvements and/or optimizations in actual manufacturing process and the resulting object (part or product, for example).

As shown in FIG. 8, the process flow may proceed from designed model 802 to selection of one or more particular AM processes 804, followed by selection of one or more AM materials 806, and then by selection of a process plan 808. Finally, process parameters may be selected. Performance evaluation 812 may then be carried out directly from the procedural code, and the results applied in the indicated iteration to adjust any of the selections in a theoretical sense. In the actual manufacturing of the object under study by way of the modeling described above, the selections may be essentially translated from theory to practice.

List below summarizes non-limiting examples of strategies that may be adapted through the iterative process illustrated in FIG. 8.

1. Compare as-manufactured with as-designed for validation of performance.

2. Compare different manufacturing processes in terms of expected performance.

3. Compare different process plans in terms of expected performance.

4. Optimize process parameters to improve performance.

5. Select infill patterns and infill ratio.

6. Select 3D printing materials and parameters.

### D. Examples of Geometry and Material Rules for Different Processes

The cell-by-cell numerical computations described above in largely conceptual terms are examples of a discretized approach commonly referred to as finite element analysis. In accordance with example embodiments, the geometry and material rules may be incorporated in finite element analysis to compute property matrices like stiffness, mass, conductivity, among others, using numerical integration. A number of examples of using geometry rules and material rules are discussed below for constructing a stiffness matrix (used in structural simulation). Stiffness serves as just one example; similar descriptions may apply to other physical properties. Each example below illustrates direct derivation from procedural code for different manufacturing plans and processes.

In accordance with example embodiments, a global stiffness matrix K may be obtained by assembling a multiplicity of element stiffness matrices Kₑ, where each Kₑ is an integration computed over a respective element geometry Qe corresponding a respective integration cell. The collection of element geometries correspond to a spatial grid, such as the one described by way of example in FIG. 6.

Each example below may be described in terms of a common general analytic form for an element stiffness matrix Kₑ, which may be expressed as:

$$\begin{matrix}{K}_{e} = {\int }_{{Ω}_{e}} {B}^{T} [ M ] B d {Ω}_{e} & ( 1 ) \\ = {\sum }_{i = 0}^{n} {B}_{i}^{T} {B}_{i} {{A}_{i} [ M ]}_{i} {w}_{i} & ( 2 ) \\ = {B}_{0}^{T} {B}_{0} {{A}_{0} [ M ]}_{0} {w}_{0} + {B}_{1}^{T} {B}_{1} {{A}_{1} [ M ]}_{1} {w}_{1} + … + {B}_{n}^{T} {B}_{n} {{A}_{n} [ M ]}_{n} {w}_{n} . & ( 3 )\end{matrix}$$

In equation (1), B is a strain-displacement matrix, [M] is a material property matrix, and the integration is carried out over the element geometry Ωₑ. The strain displacement matrix incorporates the physics applied to the object portion intersected by the Ωₑ, as well as basis functions and the boundary conditions. Although not explicitly expressed in the equations, the sum of all Kₑ yields the global stiffness matrix K.

The quadrature rules give the quadrature points i=0, . . . , n and weights wᵢ at each point i in Ωₑ. Equation (2) then expresses the integral of equation (1) as a numerical sum, where [M] is the material matrix for Ωₑ, and Aᵢ is the geometric cross-section of the road generated or laid out by the particular manufacturing process. Equation (3) expresses the expansion of the sum in equation (2) at each of the quadrature points.

As discussed above, the quadrature rules follow from the geometry rules, which may be derived directly from the procedural code (e.g., G-code). The material rules and cross-section may be implied by, or inferred from, manufacturing details relating to the specific manufacturing devices or systems, and physical processes they utilize. As discussed above, these details may be associated with a particular make and model of device (e.g., 3-D printer), and/or published data, experimental results, and the like.

In each of the examples, the analysis may be based on equations (1), (2), and (3), but differ according to the definitions and or specifications of B, [M], [M]ᵢ, and the quadrature rules (quadrature points i and weights wᵢ).

### Example 1: Fused Filament Fabrication (FFF) or Fused Deposition Modeling (FDM)

In additive manufacturing using FFF and/or FDM processes, material is deposited by extruding a filament through a nozzle. The extruded material gets deposited as a “road” along the path of the nozzle (tool path). The roads are deposited layer by layer to create the final as-manufactured shape. Two sub-examples are considered.

### Example 1.1: Basic FFF

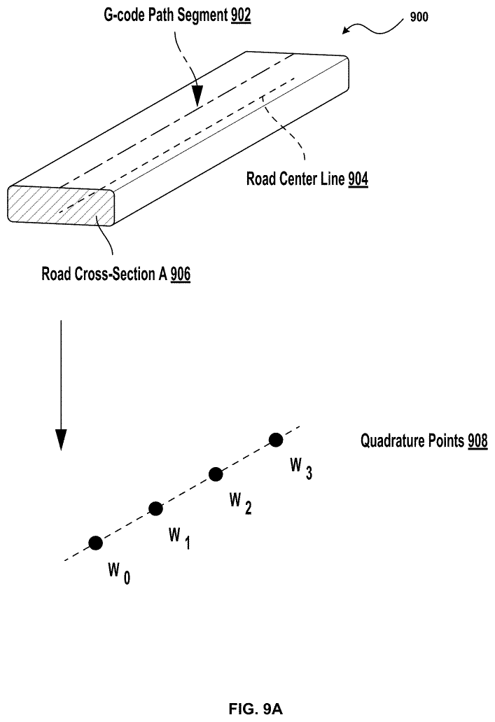

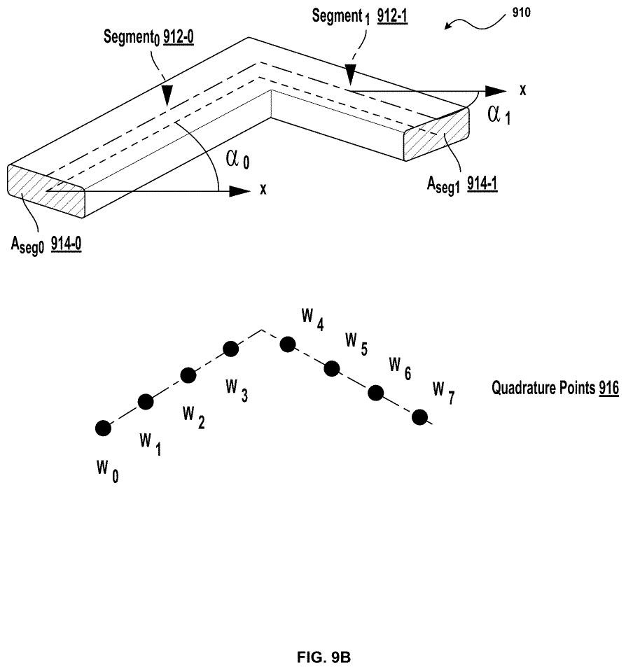

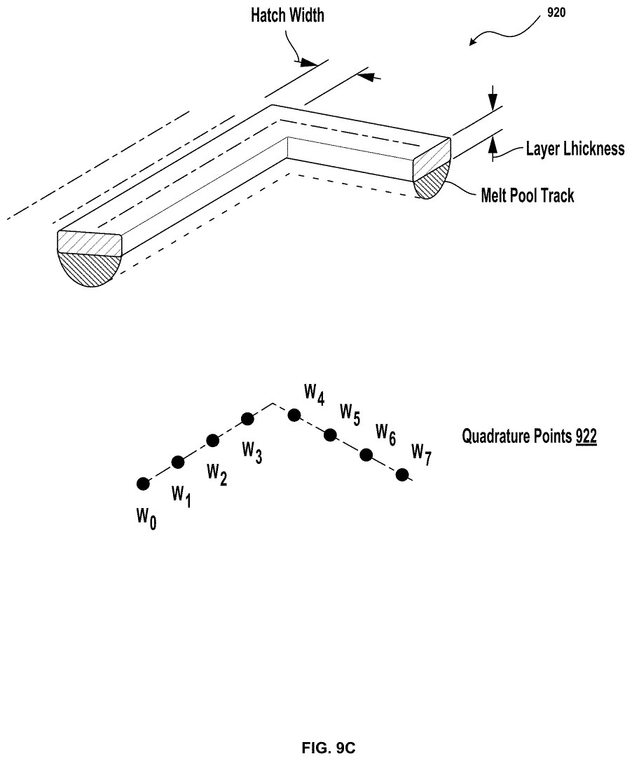

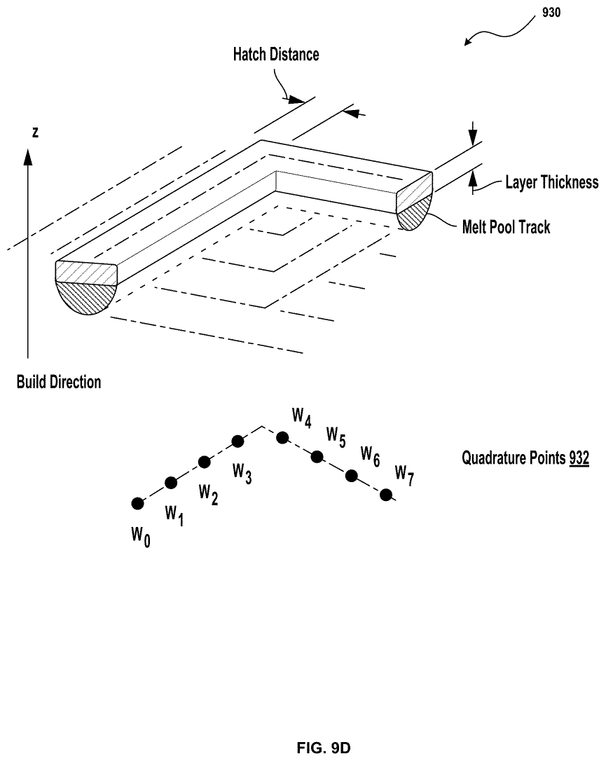

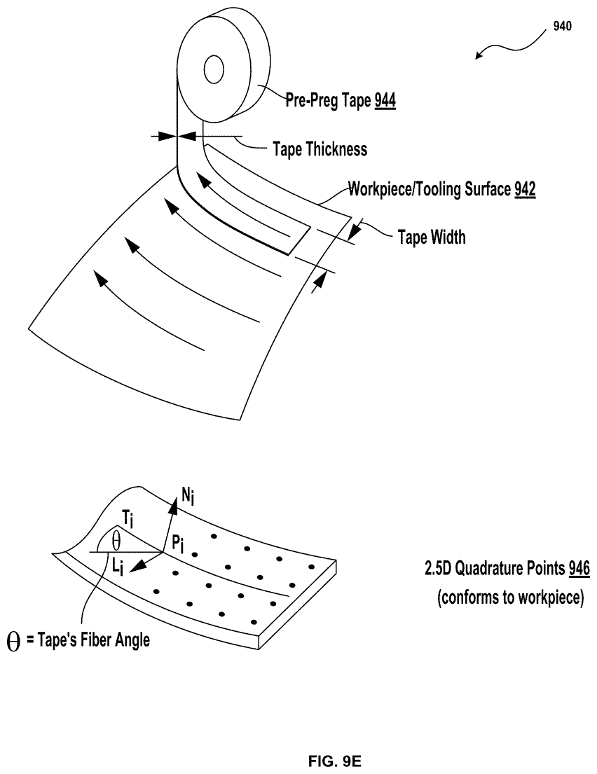

In what may be considered a simplest case, a material deposition is uniform and the deposited material has isotropic properties. FIG. 9A is conceptual illustration of an example of a basic FFF AM process, depicting a geometric representation of a portion of a road 900 laid out along a G-code path segment 902. As shown, the road 900 has a road center line 904 and road cross-section 906. The geometry rules may be also used to determine quadrature points 908 and weights at each point, as indicated.

In accordance with example embodiments, the cross section Aᵢ may be determined or derived as a function of the speed of the nozzle and the extrusion rate for each segment. These properties may be related to a particular manufacturing device, such as a specific make and model of 3-D printer, and the specific G-code generated to control the AM process for a particular part or product (or object). The quadrature points and weights follow from the quadrature rules. For this example of an isotropic material, [M] is the same for all quadrature points, and may be computed using Young's modulus and Poisson's ratio obtained from measurements, for example.

Table 2 summarizes the properties for basic FFF (example 1.1).

TABLE 2

| Geometry/ | | |
|---|---|---|
| Material Rule | Computation | Comment |
| Aᵢ | Function of nozzle | Typically, though not |
| | speed and extrusion | necessarily, identical |
| | rate for each segment | from segment to |
| | | segment and within |
| | | each segment: |
| | | (A₁ = A₂ = . . . = Aₙ) |
| wᵢ | Obtained from 1-D | May be scaled depending |
| | quadrature rule | on the segment length |
| [M]ᵢ | The isotropic property | Isotropy implies that |
| | may be computed once | this does not change from |
| | using Young's | segment to segment and |
| | modulus and Poisson's | within a segment: |
| | ratio obtained, e.g., | [M]₀ = [M]₁ = . . . = [M]ₙ |
| | from measurements | |

### Example 1.2: Anisotropic FFF

In this example, the material properties are taken to be anisotropic, and therefore they change depending on the orientation of the road. FIG. 9B is conceptual illustration of an example of an anisotropic FFF AM process, depicting a geometric representation of a portion of a road 910 laid out along two connected G-code path segments 912-0 and 912-1 that are at a non-zero angle to each other. The path of each segment has a respective orientation, α₀ and α₁, with respect to a reference coordinate system represented in this example illustration by just an x-axis. As discussed above, the reference coordinate system may also be that of the non-conforming grid, and thus independent (non-conforming) with the geometry of the object. As also shown, the road 910 has respective road cross-section A_{seg0} 914-0 and 914-1 A_{seg1} for each segment. The geometry rules may be used to determine quadrature points 916 and weights at each point, as indicated.

In accordance with example embodiments, the cross section Aᵢ may again be determined or derived as a function of the speed of the nozzle and the extrusion rate for each segment. As with the example 1.1, properties may be related to a particular manufacturing device, such as a specific make and model of 3-D printer, and the specific G-code generated to control the AM process for a particular part or product (or object). The quadrature points and weights follow from the quadrature rules. For this example of an anisotropic material, [M] depends on orientation of the path segment at each quadrature points.

Table 3 summarizes the properties for anisotropic FFF (example 1.2).

TABLE 3

| Geometry/ | | |
|---|---|---|
| Material Rule | Computation | Comment |
| Aᵢ | Same as Example 1.1 | Same as Example 1.1 |
| wᵢ | Same as Example 1.1 | Same as Example 1.1 |
| [M]ᵢ | The anisotropic | Properties change from |
| | property uses | segment to segment, but |
| | transformation | not within a segment: |
| | depending on the | [M]₀ = [M]₁ = . . . = [M]ₙ |
| | orientation of the | |
| | road line segment. | |

### Example 2: Laser Powder Bed Fusion (LPBF) or Selective Laser Sintering (SLS)

In additive manufacturing using LPBF and/or SLS processes, material is deposited when metal powder is first selectively melted by a moving heat source (e.g., a laser) and then solidified by cooling. The programmed laser movement is referred to as scanning, the offset distance between two laser paths as hatch distance, and the depth of the new powder layer added once a layer has been scanned as layer height. Two sub-examples are considered.

### Example 2.1: Basic SLS

FIG. 9C is conceptual illustration of an example of a basic SLS AM process, depicting a geometric representation of a portion of a road 920 laid out along a G-code path segment. The geometry rules may be used to determine quadrature points 922 and weights at each point, as indicated. The general form of FIG. 9C is similar to that of FIGS. 9A and 9B, so additional item labels are omitted for the sake of brevity. The hatch width, layer thickness, and melt pool track are all indicated in the figure. Table 4 summarizes the characteristics of basic SLS (example 2.1).

TABLE 4

| Geometry/ | | |
|---|---|---|
| Material Rule | Computation | Comment |
| Aᵢ | First layer: | Typically uniform within |
| | hatch distance × | each layer |
| | melt pool depth | |
| | For 100% infill: | |
| | hatch distance × | |
| | layer thickness | |
| | For single stacked: | |
| | melt pool width × | |
| | layer thickness | |
| wᵢ | Obtained from 1-D | May be scaled depending on the |
| | quadrature rule | segment length |
| [M]ᵢ | The property is | When anisotropic, it may change |
| | computed once and | from segment to segment; for both |
| | could be isotropic | cases, it does not change within a |
| | or anisotropic and | segment: |
| | may use transfor- | [M]₀ = [M]₁ = . . . = [M]ₙ |
| | mation in the | |
| | latter case. | |

### Example 2.2: Zone-Based SLS, with Material Properties Depending on which “Microstructural Zone” the Path Segments Lie

FIG. 9D is conceptual illustration of an example of a zone-based SLS AM process, depicting a geometric representation of a portion of a road 930 laid out along a G-code path segment. For zone-based SLS, the region within an integration cell may be further subdivided into microstructural zones, such that properties may be zone-dependent, and the quadrature points may be distributed across different microstructural zones. The geometry rules may be used to determine quadrature points 932 and weights at each point, as indicated. The general form of FIG. 9D is similar to that of FIG. 9C. The hatch width, layer thickness, and melt pool track are all indicated in the figure. Additional markings indicate zone boundaries. Table 5 summarizes the characteristics of zone-based SLS (example 2.2)

TABLE 5

| Geometry/ | | |
|---|---|---|
| Material Rule | Computation | Comment |
| Aᵢ | Same as Example 2.1 | Same as Example 2.1 |
| wᵢ | Same as Example 2.1 | Same as Example 2.1 |
| [M]ᵢ | The property depends | Properties could change |
| | on the microstructural | within and between segments |
| | zones, and it could be | depending on the |
| | isotropic or | microstructural zone |
| | anisotropic | containing point i and the |
| | | orientation of the |
| | | line segment |

### Example 3: Composite Automated Fiber Placement (AFP) or Automated Tape Laying (ATL)

In additive manufacturing using AFP and/or ATL processes, material is laid on a tooling surface layer by layer using fiber placement or tape laying machines. The tapes are wide in one direction (tape width) and thin in the other direction (tape thickness). In addition, the tooling surface can be curved unlike typical additive manufacturing processes.

FIG. 9E is conceptual illustration of an example of an AFP AM process, depicting a geometric representation of a portion of a road 940 laid out along a G-code path segment. A pre-preg tape 944 is laid out on a workpiece/tooling surface 942 according to the G-code. As indicated, the tape has a width and a generally small thickness. The geometry rules may be used to determine quadrature points 946, as indicated. The weights may be obtained from 2-D quadrature rules. Material properties at each quadrature point i will typically depend on an angular orientation θᵢ between the tape direction Tᵢ and tape fiber, and may use a transformation that depends on the normal direction Nᵢ. Table 5 summarizes the characteristics of AFP (example 3).

TABLE 6

| Geometry/ | | |
|---|---|---|
| Material Rule | Computation | Comment |
| Aᵢ | Tape thickness | Typically identical from |
| | | segment to segment and |
| | | within each segment: |
| | | (A₁ = A₂ = . . . = Aₙ) |
| wᵢ | Obtained from 2-D | Curved tapes can be |
| | quadrature rule | approximated as a |
| | | series of flat regions |
| [M]ᵢ | The property is anisotropic | Properties could change |
| | and uses transformation | within and between |
| | depending on surface | segments |
| | normal Nᵢ, direction | |
| | of tape Tᵢ, and tape fiber | |
| | angle θᵢ at quadrature | |
| | point i | |

### IV. Example Operation and Methods

Example methods of performance evaluation of as-manufactured objects (part, products, and the like) directly from procedural code may be implemented as machine language instructions stored in one or another form of the computer-readable storage, and accessible by the one or more processors of a computing device and/or system, and that, when executed by the one or more processors cause the computing device and/or system to carry out the various operations and functions of the methods described herein. By way of example, storage for instructions may include a non-transitory computer readable medium. In example operation, the stored instructions may be made accessible to one or more processors of a computing device or system. Execution of the instructions by the one or more processors may then cause the computing device or system to carry out various operations of the example method.

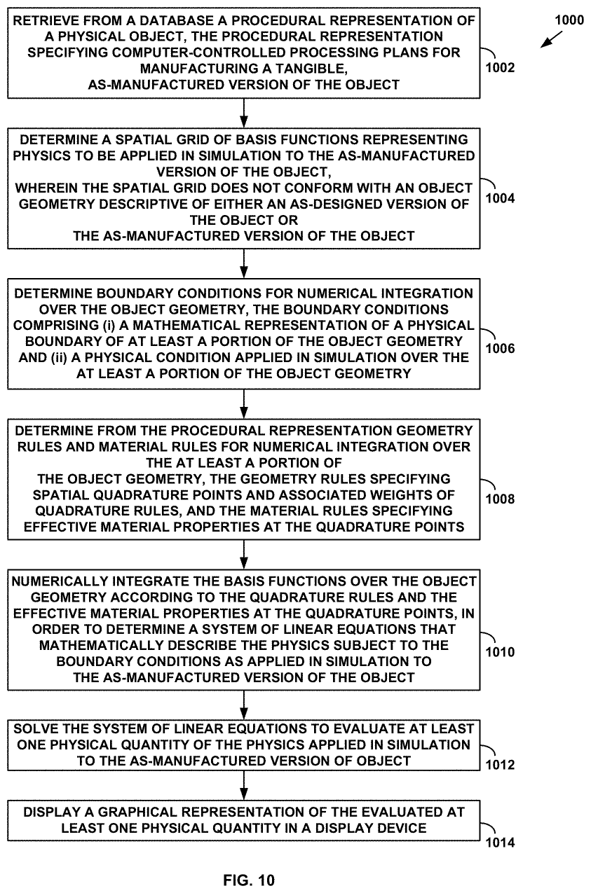

FIG. 10 is a flow chart of an example method 1000, according to example embodiments. As described above, the example method could implemented as machine language instructions stored, for example in the memory 104, and executed by the processor(s) 102 of the computing device 100 illustrated in FIG. 1.

At step 1002, the computing device may retrieve from a database a procedural representation of the object. The procedural representation may specify computer-controlled processing plans for manufacturing a tangible, as-manufactured version of the object.

At step 1004, the computing device may determine a spatial grid of basis functions representing physics to be applied in simulation to the as-manufactured version of the object. The spatial grid does not conform with an object geometry descriptive of either an as-designed version of the object or the as-manufactured version of the object.

At step 1006, the computing device may determine boundary conditions for numerical integration over the object geometry. The boundary conditions include (i) a mathematical representation of a physical boundary of at least a portion of the object geometry and (ii) a physical condition applied in simulation over the at least a portion of the object geometry.

At step 1008, the computing device may determine from the procedural representation geometry rules and material rules for numerical integration over the at least a portion of the object geometry. The geometry rules specify spatial quadrature points and associated weights of quadrature rules, and the material rules specify effective material properties at the quadrature points.

At step 1010, the computing device may numerically integrate the basis functions over the object geometry according to the quadrature rules and the effective material properties at the quadrature points, in order to determine a system of linear equations that mathematically describe the physics subject to the boundary conditions as applied in simulation to the as-manufactured version of the object.

At step 1012, the computing device may solve the system of linear equations to evaluate at least one physical quantity of the physics applied in simulation to the as-manufactured version of object.

Finally, at step 1014, a graphical representation of the evaluated at least one physical quantity may be displayed in a display device.

In accordance with example embodiments, the procedural representation may be generated from a design specification of the object describing an as-designed version of the object. In an example embodiment, the procedural representation may be G-code.

In accordance with example embodiments, the object geometry may be one of an as-designed geometry of the object derived from a design specification of the object, or an as-manufactured geometry of the object derived from the procedural representation.

In accordance with example embodiments, the spatial grid may be a set of contiguous volume elements for discretizing analysis of the as-manufactured version of the object, the set of contiguous volume elements being defined by coordinates independent of the object geometry. With this arrangement, determining the spatial grid of basis functions representing physics to be applied in simulation to the as-manufactured version of the object may involve specifying a spatial resolution of the volume elements, and specifying an analytical form for the basis functions.

In further accordance with example embodiments, determining boundary conditions may entail mapping a source geometry to the object geometry within the volume elements, and evaluating an analytical expression of the physical condition over respective portions of the object geometry intersected by the volume elements. The source geometry may be an as-designed geometry of the as-designed object, an as-planned geometry descriptive of the as-manufactured version of the object within the volume elements, or the procedural representation evaluated within the volume elements.

In further accordance with example embodiments, determining from the procedural representation geometry rules and material rules for numerical integration over the at least a portion of the object geometry may entail determining an intersection of each volume element with a planned manufacturing path, determining a respective set of quadrature points and associated quadrature weights along the planned manufacturing path intersected by each volume element, and determining elemental material properties and elemental geometries of as-planned incrementally-manufactured elements produced along the planned manufacturing path. The planned manufacturing path may be specified by the procedural representation, and the elemental material properties may include material properties of a manufacturing material specified by the procedural representation.

In further accordance with example embodiments, numerically integrating the basis functions over the object geometry according to the quadrature rules and the effective material properties at the quadrature points may involve, for each given volume element, computing an elemental sum of a product of the basis functions, the boundary conditions, the effective material properties, and the weights at the quadrature points within the given volume element, and computing a sum of the elemental sums.

In accordance with example embodiments, the physics to be applied in simulation to the as-manufactured version of the object may be physics of the at least one physical quantity, the at least one physical quantity being: displacement, stress, strain, temperature, or heat flux.

In accordance with example embodiments, the example method may further include comparing the evaluated at least one physical quantity with a prediction of the at least one physical quantity determined from a design specification of the physical object.

### CONCLUSION

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method for simulation of physical performance of a physical object directly from a manufacturing process plan for the physical object, the method being carried out by a computing device and comprising:
retrieving from a database a procedural representation of the object, the procedural representation specifying computer-controlled processing plans for manufacturing a tangible, as-manufactured version of the object;
determining a spatial grid of basis functions representing physics to be applied in simulation to the as-manufactured version of the object, wherein the spatial grid does not conform with an object geometry descriptive of either an as-designed version of the object or the as-manufactured version of the object;
determining boundary conditions for numerical integration over the object geometry, the boundary conditions comprising (i) a mathematical representation of a physical boundary of at least a portion of the object geometry and (ii) a physical condition applied in simulation over the at least a portion of the object geometry;
determining from the procedural representation geometry rules and material rules for numerical integration over the at least a portion of the object geometry, wherein the geometry rules specify spatial quadrature points and associated weights of quadrature rules, and the material rules specify effective material properties at the quadrature points;
numerically integrating the basis functions over the object geometry according to the quadrature rules and the effective material properties at the quadrature points, in order to determine a system of linear equations that mathematically describe the physics subject to the boundary conditions as applied in simulation to the as-manufactured version of the object;
solving the system of linear equations to evaluate at least one physical quantity of the physics applied in simulation to the as-manufactured version of object; and
displaying a graphical representation of the evaluated at least one physical quantity in a display device.

2. The method of claim 1, wherein the procedural representation is generated from a design specification of the object describing an as-designed version of the object.

3. The method of claim 1, wherein the procedural representation comprises G-code.

4. The method of claim 1, wherein the object geometry is one of an as-designed geometry of the object derived from a design specification of the object, or an as-manufactured geometry of the object derived from the procedural representation.

5. The method of claim 1, wherein the spatial grid comprises a set of contiguous volume elements for discretizing analysis of the as-manufactured version of the object, the set of contiguous volume elements being defined by coordinates independent of the object geometry,
and wherein determining the spatial grid of basis functions representing physics to be applied in simulation to the as-manufactured version of the object comprises:
specifying a spatial resolution of the volume elements; and
specifying an analytical form for the basis functions.

6. The method of claim 5, wherein determining boundary conditions comprises:
mapping a source geometry to the object geometry within the volume elements, wherein the source geometry is one of an as-designed geometry of the as-designed object, an as-planned geometry descriptive of the as-manufactured version of the object within the volume elements, or the procedural representation evaluated within the volume elements; and
evaluating an analytical expression of the physical condition over respective portions of the object geometry intersected by the volume elements.

7. The method of claim 5, wherein determining from the procedural representation geometry rules and material rules for numerical integration over the at least a portion of the object geometry comprises:
determining an intersection of each volume element with a planned manufacturing path, the planned manufacturing path being specified by the procedural representation;
determining a respective set of quadrature points and associated quadrature weights along the planned manufacturing path intersected by each volume element; and
determining elemental material properties and elemental geometries of as-planned incrementally-manufactured elements produced along the planned manufacturing path, the elemental material properties comprising material properties of a manufacturing material specified by the procedural representation.

8. The method of claim 7, wherein numerically integrating the basis functions over the object geometry according to the quadrature rules and the effective material properties at the quadrature points comprises:
for each given volume element, computing an elemental sum of a product of the basis functions, the boundary conditions, the effective material properties, and the weights at the quadrature points within the given volume element; and
computing a sum of the elemental sums.

9. The method of claim 1, wherein the physics to be applied in simulation to the as-manufactured version of the object comprises physics of the at least one physical quantity, the at least one physical quantity being: displacement, stress, strain, temperature, or heat flux.

10. The method of claim 1, further comprising comparing the evaluated at least one physical quantity with a prediction of the at least one physical quantity determined from a design specification of the physical object.

11. A system for simulation of physical performance of a physical object directly from a manufacturing process plan for the physical object, the system comprising:
one or more processors;
memory,
and instructions stored in the memory that, when executed by the one or more processors, cause the system to carry out operations including:
retrieving from a database a procedural representation of the object, the procedural representation specifying computer-controlled processing plans for manufacturing a tangible, as-manufactured version of the object;
determining a spatial grid of basis functions representing physics to be applied in simulation to the as-manufactured version of the object, wherein the spatial grid does not conform with an object geometry descriptive of either an as-designed version of the object or the as-manufactured version of the object;
determining boundary conditions for numerical integration over the object geometry, the boundary conditions comprising (i) a mathematical representation of a physical boundary of at least a portion of the object geometry and (ii) a physical condition applied in simulation over the at least a portion of the object geometry;
determining from the procedural representation geometry rules and material rules for numerical integration over the at least a portion of the object geometry, wherein the geometry rules specify spatial quadrature points and associated weights of quadrature rules, and the material rules specify effective material properties at the quadrature points;
numerically integrating the basis functions over the object geometry according to the quadrature rules and the effective material properties at the quadrature points, in order to determine a system of linear equations that mathematically describe the physics subject to the boundary conditions as applied in simulation to the as-manufactured version of the object;
solving the system of linear equations to evaluate at least one physical quantity of the physics applied in simulation to the as-manufactured version of object; and
displaying a graphical representation of the evaluated at least one physical quantity in a display device.

12. The system of claim 11, wherein the procedural representation is generated from a design specification of the object describing an as-designed version of the object, and wherein the procedural representation comprises G-code.

13. The system of claim 11, wherein the object geometry is one of an as-designed geometry of the object derived from a design specification of the object, or an as-manufactured geometry of the object derived from the procedural representation.

14. The system of claim 11, wherein the spatial grid comprises a set of contiguous volume elements for discretizing analysis of the as-manufactured version of the object, the set of contiguous volume elements being defined by coordinates independent of the object geometry,
and wherein determining the spatial grid of basis functions representing physics to be applied in simulation to the as-manufactured version of the object comprises:
specifying a spatial resolution of the volume elements; and
specifying an analytical form for the basis functions.

15. The system of claim 11, wherein determining boundary conditions comprises:
mapping a source geometry to the object geometry within the volume elements, wherein the source geometry is one of an as-designed geometry of the as-designed object, an as-planned geometry descriptive of the as-manufactured version of the object within the volume elements, or the procedural representation evaluated within the volume elements; and
evaluating an analytical expression of the physical condition over respective portions of the object geometry intersected by the volume elements.

16. The system of claim 11, wherein determining from the procedural representation geometry rules and material rules for numerical integration over the at least a portion of the object geometry comprises:
determining an intersection of each volume element with a planned manufacturing path, the planned manufacturing path being specified by the procedural representation;
determining a respective set of quadrature points and associated quadrature weights along the planned manufacturing path intersected by each volume element; and
determining elemental material properties and elemental geometries of as-planned incrementally-manufactured elements produced along the planned manufacturing path, the elemental material properties comprising material properties of a manufacturing material specified by the procedural representation.

17. The system of claim 11, wherein numerically integrating the basis functions over the object geometry according to the quadrature rules and the effective material properties at the quadrature points comprises:
for each given volume element, computing an elemental sum of a product of the basis functions, the boundary conditions, the effective material properties, and the weights at the quadrature points within the given volume element; and
computing a sum of the elemental sums.

18. The system of claim 11, wherein the physics to be applied in simulation to the as-manufactured version of the object comprises physics of the at least one physical quantity, the at least one physical quantity being: displacement, stress, strain, temperature, or heat flux.

19. The system of claim 11, wherein the operations further include comparing the evaluated at least one physical quantity with a prediction of the at least one physical quantity determined from a design specification of the physical object.

20. A non-transitory computer-readable medium having instructions stored thereon that, when executed by the one or more processors of a system for simulation of physical performance of a physical object directly from a manufacturing process plan for the physical object, cause the system to carry out operations including:
retrieving from a database a procedural representation of the object, the procedural representation specifying computer-controlled processing plans for manufacturing a tangible, as-manufactured version of the object;
determining a spatial grid of basis functions representing physics to be applied in simulation to the as-manufactured version of the object, wherein the spatial grid does not conform with an object geometry descriptive of either an as-designed version of the object or the as-manufactured version of the object;
determining boundary conditions for numerical integration over the object geometry, the boundary conditions comprising (i) a mathematical representation of a physical boundary of at least a portion of the object geometry and (ii) a physical condition applied in simulation over the at least a portion of the object geometry;
determining from the procedural representation geometry rules and material rules for numerical integration over the at least a portion of the object geometry, wherein the geometry rules specify spatial quadrature points and associated weights of quadrature rules, and the material rules specify effective material properties at the quadrature points;
numerically integrating the basis functions over the object geometry according to the quadrature rules and the effective material properties at the quadrature points, in order to determine a system of linear equations that mathematically describe the physics subject to the boundary conditions as applied in simulation to the as-manufactured version of the object;
solving the system of linear equations to evaluate at least one physical quantity of the physics applied in simulation to the as-manufactured version of object; and
displaying a graphical representation of the evaluated at least one physical quantity in a display device.
